(19) United States
(12) Patent Application Publication
(10) Pub. No.: US 2014/0313101 A1
(43) Pub. Date: Oct. 23, 2014

(54) ELECTRONIC DEVICE AND METHOD FOR IMAGE CONTENT ASSIGNMENT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: MING-TSUNG CHEN, New Taipei (TW); MING-FENG TSAI, New Taipei (TW); YA-JUN ZHAO, Shenzhen (CN)

(73) Assignees: HONG FU JIN PRECISION INDUSTRY (ShenZhen) CO., LTD., ShenZhen (CN); HON HAI PRECISION INDUSTRY CO., LTD., New Taipei (TW)

(21) Appl. No.: 14/258,098

(22) Filed: Apr. 22, 2014

(30) Foreign Application Priority Data
Apr. 22, 2013 (CN) 2013101398651

(51) Int. Cl. G06F 3/14

(52) U.S. Cl. CPC G06F 3/1446; G06F 3/1431
USPC 345/1.3

(57) ABSTRACT

In a method for assigning image content displayed on electronic devices connected to a server, each electronic device has display screens. The server determines image content for each electronic device, organizes the determined image contents of each electronic device according to configuration information of display screens of each electronic device, packets the organized image contents of each of the electronic devices into a data packet according to the configuration information, with each data packet being associated to a destination electronic device, and sends the data packets to the electronic devices. Each electronic device can obtain image content from the data packet if the electronic device is a destination electronic device of the data packet, in addition, can assign image content for each display screen of the current electronic device to display according to the configuration information of the display screens.

### FIELD

The present disclosure relates to display technology, and particularly to an electronic device and a method for assigning image content displayed on the electronic device having display screens.

### BACKGROUND

Advertising companies now tend to use advertising devices, such as electronic billboards, to dynamically display advertising outdoors or in public places. The electronic billboards have different sizes to adapt to different advertising places.

### BRIEF DESCRIPTION OF THE DRAWINGS

Many aspects of the embodiments described herein can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of one embodiment for connections among electronic devices, which include a master electronic device and slave electronic devices.

FIG. 2 is a block diagram of each of the slave electronic devices of FIG. 1.

FIG. 3 is a block diagram of the master electronic devices of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one”.

In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

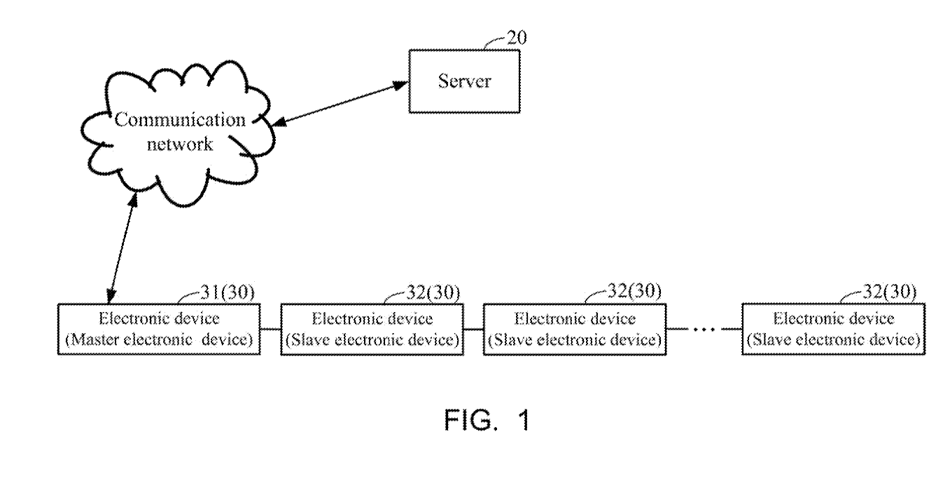

FIG. 1 illustrates a schematic diagram of one embodiment for coupling among electronic devices 30. In the embodiment, a master electronic device 31 and slave electronic devices 32 can be included. The master electronic device 31 can be coupled to the slave electronic devices 32 through wired or wireless connections, such as RJ-45, Wi-Fi, BLUETOOTH, for example. The connection between the master electronic device 31 and the slave electronic devices 32 can also be an intranet or the Internet. The master electronic device 31 can be further connected to a server 20 through a communication network to transmit information between the server 20 and the electronic devices 30. In the embodiment, each of the master electronic device 31 and the second electronic devices 32 can be a billboard.

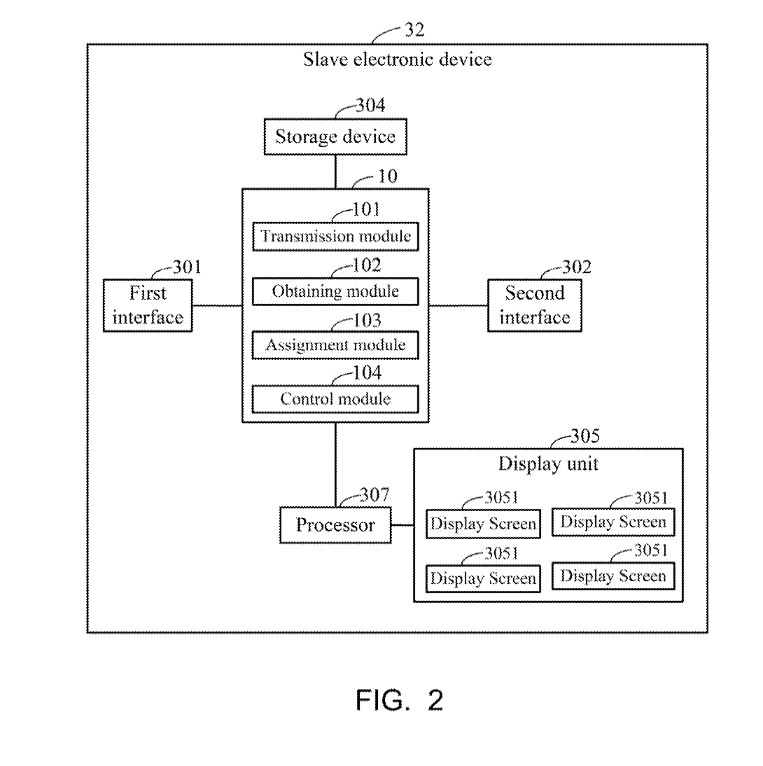

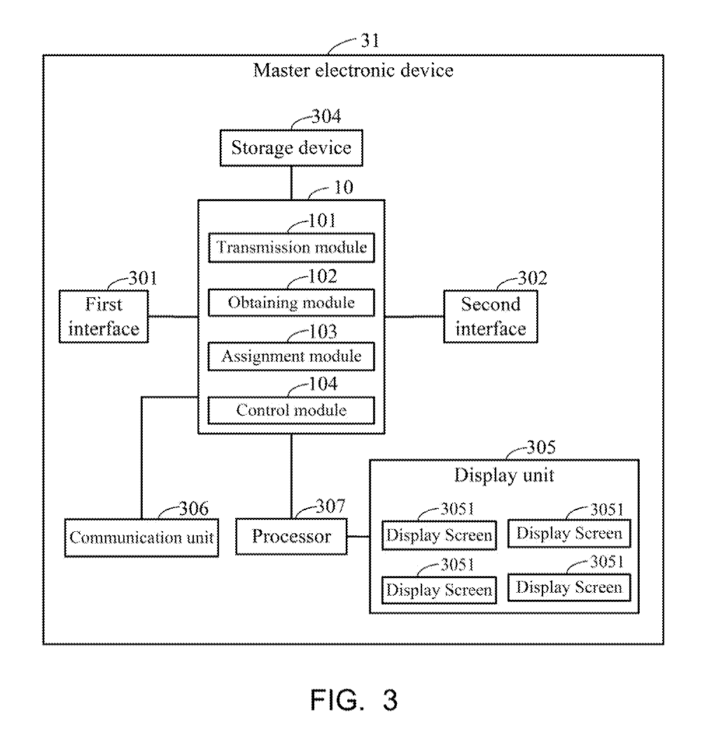

FIGS. 2 and 3 illustrate block diagrams of one embodiment of the master electronic device 31 and the slave electronic devices 32. An image contents assignment system 10 can be included in each of the master electronic device 31 and the slave electronic devices 32. Each electronic device 30 further can include, but is not limited to a first interface 301, a second interface 302, a storage device 304, a display unit 305 and at least one processor 307. Each electronic device 30 may be coupled to the other two electronic devices 30 through the first interface 301 and the second interface 302. In one embodiment, the slave electronic devices 32 can be coupled in sequence and a first slave electronic device 32 can be coupled to the master electronic device 31.

The display unit 305 can include a number of display screens 3051, the display screens 3051 can be spliced together to form a large screen. In one embodiment, each of the display screens 3051 can be an electronic-paper display, a Liquid Crystal Display (LCD) screen, or any other screen.

In at least one embodiment, each of the electronic devices 30 is provided with a unique identification (UID) for unique identification by other devices. Each display screen 3051 can be provided with a serial number. In at least one embodiment, the serial number can be used to distinguish the positions of the display screens 3051 arranged on the display unit 305. For example, a display unit 305 can include four display screens 3051 arranged in a matrix array, in directions from left to right, and from up to down, each of the four display screens 3051 can be provided with a serial number 1, 2, 3 and 4.

In at least one embodiment, the storage device 304 of each of the electronic devices 30 further can store configuration information of the current electronic device, which can include the UID of the current electronic device and the serial numbers of the display screens of the current electronic device.

The image contents assignment system 10 can assign image content for each of the display screens 3051 to display. In one at least embodiment, the image contents assignment system 10 can comprise computerized instructions in the form of one or more computer-readable programs stored in the storage device 304 and executed by the at least one processor 307. FIGS. 2 and 3 depict only one example of the master electronic device 31 and the slave electronic devices 32, other examples may comprise more or fewer components than those shown in the embodiment, or have a different configuration of the various components.

In at least one embodiment, the storage device 304 can be an internal storage system, such as a flash memory, a random access memory (RAM) for temporary storage of information, and/or a read-only memory (ROM) for permanent storage of information.

The storage device 304 can also be an external storage system, such as an external hard disk, a storage card, or a data storage medium. The at least one processor 307 can be a central processing unit (CPU), a microprocessor, or other data processor chip that performs various functions of the master electronic device 31 and the slave electronic devices 32.

In at least one embodiment, the image contents assignment system 10 can include one or more modules, for example, a transmission module 101, an obtaining module 102, an assignment module 103, and a control module 104. The modules 101-104 can comprise computerized instructions in the form of one or more computer-readable programs that can be stored in a non-transitory computer-readable medium (such as the storage device 304) and can be executed by the at least one processor 307 of the master electronic device 31 and the slave electronic devices 32.

The transmission module 101 of each of the electronic devices 30 can send the configuration information of each of the electronic devices 30 to the server 20.

The master electronic device 31 further can include a communication unit 306. The control module 104 in each of the electronic devices 30 can determine a role of each of the electronic devices 30 to be a master electronic device or a slave electronic device. In at least one embodiment, the control module 104 can determine the current electronic device 30 residing in a to be a master electronic device if the communication unit 306 of the current electronic device 30 communicates with the server 20, or can determine the current electronic device 30 to be a slave electronic device if the communication unit 306 does not communicate with the server 20.

The transmission module 101 of each of the slave electronic devices 32 can transmit their configuration information to the transmission module 101 of the master electronic device 31, and the communication unit 306 of the master electronic device 31 can transmit the configuration information of the master electronic device 31 and the slave electronic devices 32 to the server 20.

The server 20 may determine image contents for each of the electronic devices 30, and reorganize the determined image contents of each of the electronic devices according to the configuration information of display screens 3051 of each of the electronic devices 30. The server 20 can further packet the organized image contents of each of the electronic devices into a data packet according to the configuration information, with each data packet being associated to a destination electronic device 30, and can send the data packets to the master electronic device 31.

The master electronic device 31 can receive the data packets through the communication unit 306, and if the master electronic device 31 is not the destination electronic device 30 of the data packets, the transmission module 101 of the master electronic device 31 can further transmit the data packets to the first slave electronic device 32 in order,. If the first slave electronic device 32 is also not the destination electronic device 30 of the data packets, the first slave electronic device 32 can further pass the data packets to a second slave electronic device 32 following the first slave electronic device 32. As such, the data packets can travel among the electronic devices 30 until they reach their respective destination.

The obtaining module 102 of each of the destination electronic devices 30 can obtain image contents from the correspondingly data packet.

The assignment module 103 of each destination electronic device 30 can assign the image content for each of the display screens 3051 according to the configuration information of the display screens 3051 of the destination electronic device 30.

The control module 104 of each of the destination electronic devices 30 can control each of the display screens 3051 of the destination electronic device to display corresponding image content. Therefore, a large display area can be obtained by splicing multiple electronic devices having multiple display screens.

Moreover, it is to be understood that the disclosure may be embodied in other forms without departing from the spirit thereof. Thus, the present examples and embodiments are to be considered in all respects as illustrative, of the following claims and not restrictive.

What is claimed is:

1. A method for assigning image contents displayed on an electronic device connected to a server, the electronic device having display screens, the method comprising:
sending configuration information of the display screens of the electronic device to the server;
receiving data packets from the server at the electronic device, and obtaining image contents from a data packet if the electronic device is a destination electronic device of the data packet;
assigning image content for each of the display screens of the electronic device according to the configuration information of the display screens;
controlling each of the display screens to display corresponding image content.

2. The method as described in claim 1, wherein the configuration information comprises serial numbers of the display screens.

3. A method for assigning image contents displayed on electronic devices connected to a server, each of the electronic devices having display screens, the method comprising:
receiving configuration information of the display screens of the electronic devices, and determining image contents for each of the electronic devices;
organizing the determined image contents of each of the electronic devices according to the configuration information of display screens of each of the electronic devices;
packeting the organized image contents of each of the electronic devices into at least one data packet according to the configuration information, with each data packet being associated to a destination electronic device;
sending the data packets to the electronic devices.

4. An electronic device, comprising:
a display unit comprising a plurality of display screens spliced together to form a large screen;
at least one processor; and
a storage device storing a plurality of instructions, which when executed by the at least one processor, causes the at least one processor to:
send configuration information of the display screens of the electronic device to a server;
receive data packets from the server, and obtain image contents from a data packet if the electronic device is a destination electronic device of the data packet;
assign image content for each of the display screens according to the configuration information of the display screens; and
control each of the display screens to display corresponding image content.

5. The electronic device as described in claim 4, wherein the at least one processor further determines a role of the electronic device to be a slave electronic device or a master electronic device.

6. The electronic device as described in claim 5, further comprising a communication unit, wherein the at least one processor determines a role of the electronic device to be a slave electronic device or a master electronic device by:
determining the electronic device to be a master electronic device if the at least one processor determines that the communication unit communicate with the server, or determining the electronic device to be a slave electronic device if the at least one processor determines that the communication unit does not communicate with the server.

7. The electronic device as described in claim 4, wherein each of the display screens is provided with a serial number, which used to distinguish the positions of the display screens arranged on the display unit, and the configuration information of the display screens comprise the serial numbers of the display screens.

8. The electronic device as described in claim 4, further comprising a first interface and a second interface, wherein the electronic device communicates with other electronic devices through the first interface and the second interface.

9. The electronic device as described in claim 4, wherein each of the display screens of the electronic device is an electronic-paper display or a Liquid Crystal Display screen.
